(19) United States
(12) Patent Application Publication
(10) Pub. No.: US 2004/0084407 A1
(43) Pub. Date: May 6, 2004

(54) Method for surface preparation to enable uniform etching of polycrystalline materials

(75) Inventors: Vladimir V. Makarov, Palo Alto, CA (US); William B. Thompson, Los Altos, CA (US); Theodore R. Lundquist, Dublin, CA (US)

Correspondence Address: William L. Botjer, PO Box 478, Center Moriches, NY, 11934, US

(73) Assignee: NPTEST, INC., SAN JOSE, CA

(21) Appl. No.: 10/284,845

(22) Filed: Oct. 31, 2002

(51) Int. Cl. H01B 13/00

(52) U.S. Cl. 216/62

(57) ABSTRACT

A method for surface preparation of a polycrystalline material prior to etching. The material surface is amorphized by two particle beam bombardments s on the material surface. These energized particles break the crystal structure of the crystalline material and convert it into amorphous material. The two particle beams are oriented to each other at an angle of at least twice of the critical angle of channeling for the most open crystal structure in the material. This ensures amorphization of the material surface regardless of the different grain orientations on the surface. The amorphous surface has isotropic surface properties and thus allows uniform etching. The uniformity in surface properties allows better control over etching process and reduces damage to underlying and adjacent material.

### BACKGROUND

The present invention relates generally to the etching of surfaces and thin films of polycrystalline materials. More specifically, it relates to a method for surface preparation by amorphization of polycrystalline materials, such as metallic interconnects, wire and planes in integrated circuits.

Etching is one of the primary processes used in the fabrication of microelectronic and miniature components. It is used for defining high-resolution features as well as for surface smoothening and further film deposition in the fabrication process. There are three main factors considered while etching viz., i) etching rate, ii) selectivity and iii) uniformity. Etching rate is the rate of removal of material using the etching process. It depends on the etching technique used along with its various parameters as well as the material to be etched. Selectivity refers to the etching action occurring within a specific region for which one material type is etched more rapidly than another. Selectivity is usually defined as the ratio of the etch rate of one material to the other. Uniformity refers to the limited variation of the etching rate on the etched material surface across the operation region, and is a major consideration for the etching process. It reduces the damage to underlying and adjacent material from non-uniform etching.

There are several techniques existing in the art that provide for localized surface etching. One of the most widely used methods is wet chemical etching wherein the surface to be etched is treated with specific chemical solutions. These chemical solutions react with the surface molecules and dissolve them.

Current state of the art in etching techniques includes dry or plasma etching as a substitute to the above-mentioned method. Dry etching utilizes plasma driven chemical reactions and/or reactive ion beams to remove material. There are several variations of the above-mentioned dry etching method known in the art such as, chemically assisted ion etching, reactive ion etching, ion-beam milling etc. U.S. Pat. No. 3,676,317, titled “Sputter etching process” assigned to Stromberg Datagraphix, Inc and U.S. Pat. No. 4,557,796, titled “Method of dry copper etching and its implementation” assigned to International Business Machines Corporation, discloses a method of dry etching.

However, the above etching techniques provide a uniform surface only if the surface properties are isotropic. In cases where the surface has polycrystalline grain structure the grains at the surface have different crystallographic orientations. This leads to different etching rates for the grains thus causing non-uniform material removal from the surface during the etching process.

There are some methods that attain a uniform surface in monocrystalline materials. These methods use an amorphization process to amorphize the material surface prior to etching process. Amorphization is the process by which crystal structure of a material is disrupted to get an amorphous solid. In other words, it is the reduction of long-range order of a crystalline structure. This may be achieved by bombarding particle beams on the surface of the material; these energized particles interact with the atomic lattices and break the existing crystal structure. Thus the crystallographic orientation of the material surface is destroyed to get uniform surface properties. This enables uniform material removal from the surface of the material during the process of etching.

One such method has been disclosed in U.S. Pat. No. 6,303,472, titled “Process for cutting trenches in a single crystal substrate” assigned to STMicroelectronics S.r.I. In this method, the silicon substrate is amorphized prior to cutting trenches in the substrate. Another method has been disclosed in U.S. Pat. No. 5,436,174, titled “Method of forming trenches in monocrystalline silicon carbide” assigned to North Carolina State University. In this method, silicon carbide substrate is amorphized prior to etching process. The amorphization of the silicon carbide surface in the above invention aids in uniform etching of the surface.

However, the above inventions are only suited for amorphizaton of monocrystalline materials such as, silicon carbide, silicon etc. These inventions do not address the problem of uniform etching of polycrystalline materials.

In polycrystalline materials, the local surface properties are not uniform across the surface. The surface has grains with different orientations, which leads to significant anisotropic properties, i.e., the properties are dependent on the direction and orientation of the different grains exposed to etching, resulting in different etching rates. This may lead to uneven material removal during etching process.

For example, ion beam etching of copper, which is normally a polycrystalline material, leads to strong roughness formation on the surface of etched copper. This is better illustrated with the help of FIG. 1. Polycrystalline material 100 is made up of several grains as illustrated in FIG. 1A. Three such grains 102, 104 and 106 have been shown in the figure. They have different orientations and are etched at different rates, resulting in an uneven texture as shown in FIG. 1B. Also, in the etching of thin films there is often preferential local etching of certain favorably oriented regions. In such cases, an etchant may penetrate the surface film and damage the underlying substrate material.

Additionally, certain grains may not be amorphized by the particle beam due to “Channeling Effect”. The channeling effect occurs when atoms in a crystal are oriented in such a manner with respect to the ion beam, that a majority of ions experience only weak collisions with the lattice atoms, deviate only weakly and move along “transparent” directions called “channels”. Thus, the beam passes through the lattice without affecting it. Therefore, such grains retain their crystal structure while the rest of the grains are amorphized. These crystalline grains require more time to be etched away compared to the amorphized grains during the etching process.

For polycrystalline materials that show a crystallographic dependence on etching rates, the surface needs to be prepared in a manner so as to ensure isotropic surface properties. This is particularly important because polycrystalline materials like copper, gold, silver and titanium are widely used as material for wiring in modern microchips. For patterning of microchips with an etching technique (such as the focused ion-beam etching (FIB)), copper planes and traces have to be cut evenly to ensure controlled etching. These copper planes and traces consist of crystal grains each having a specific crystallographic orientation with different etching rates under FIB operation.

Additionally, in integrated circuits metallic interconnects are embedded in various layers of the substrate. In order to repair or edit an embedded metal interconnect in an integrated circuit, the metal surface has to be exposed from under the overlayers of substrate followed by etching of the interconnect. The circuit components may be of the order of submicrons in size and therefore the process requires high precision to uniformly etch an embedded metal interconnect along its surface and across its vertical thickness.

Accordingly, there is a need for a method for surface preparation that can enable uniform etching, even in the case of polycrystalline materials. There is also a need for a method of amorphization of crystalline materials such that the channeling effect in grains is overcome in a more efficient manner. There is also a need for a method that can be used to improve the vertical precision in etching in case of metallic interconnects embedded in layers of dielectric within the integrated circuits.

### SUMMARY

An object of the present invention is to prepare the surface of a polycrystalline material prior to etching, so as to ensure uniform etching of the material.

A further object of the present invention is to prepare the surface of a crystalline material prior to etching, so as to ensure better control over the etching process.

Another object of the present invention is to quicken the amorphization process by efficiently overcoming the channeling effect in crystalline structure.

Yet another object of the present invention is to amorphize surface of a polycrystalline material using two particle beams.

The present invention utilizes two particle beams to bombard material surface. These energized particles break the crystal structure of the material and thus convert the material into amorphous form. The two particle beams are inclined to each other at an angle of at least twice of the critical angle of channeling for the most open crystal structure in the material. These beams may or may not operate simultaneously on the operation region. This operation ensures that all the grains on the material surface are amorphized irrespective of their orientations. Amorphized surfaces have isotropic surface properties and therefore can be uniformly etched across the operation region. The uniformity in etching over the surface leads to more control and precision over the etching process. More control over the etching process leads to minimizing damage to underlying and adjacent material, including dielectrics, which protrude into and through the polycrystalline material during the etching process.

### BRIEF DESCRIPTION OF DRAWINGS

The preferred embodiments of the invention will hereinafter be described in conjunction with the appended drawings provided to illustrate and not to limit the invention, wherein like designations denote like elements, and in which:

FIG. 1A depicts a surface of a polycrystalline material prior to an etching operation;

FIG. 1B depicts the surface of the polycrystalline material after an etching operation in accordance with prior art;

FIG. 2 is a schematic representation of the etching process in accordance with a preferred embodiment of the current invention;

FIG. 3 depicts the amorphization process in accordance with a preferred embodiment of the current invention;

FIG. 4 illustrates the relative directions of the incident particle beams in case of overcoming plane channeling effect in materials.

FIG. 5A shows particle bombardment on a simple cubic lattice structure;

FIG. 5B shows particle bombardment on another simple cubic lattice structure in a different orientation;

FIG. 6 illustrates the two-angle amorphization arrangement used in the present invention; and

FIG. 7 shows an application of the present invention in the case of embedded metallic surfaces in integrated circuits.

### DESCRIPTION OF PREFERRED EMBODIMENTS

The present invention is a method for surface preparation of a material in order to enable uniform etching of the surface. This is done by amorphizing the surface of the material prior to the etching operation, by using particle beam bombardment. Amorphization may be defined as reduction in long-range order of a crystalline structure by disrupting the crystal structure. Amorphization is performed by particle beam bombardment onto the surface from at least two different angles with respect to the surface normal. In this manner, any local non-uniformity in crystallographic orientation on the surface is destroyed, thereby inducing isotropic surface properties on the surface of the crystalline material.

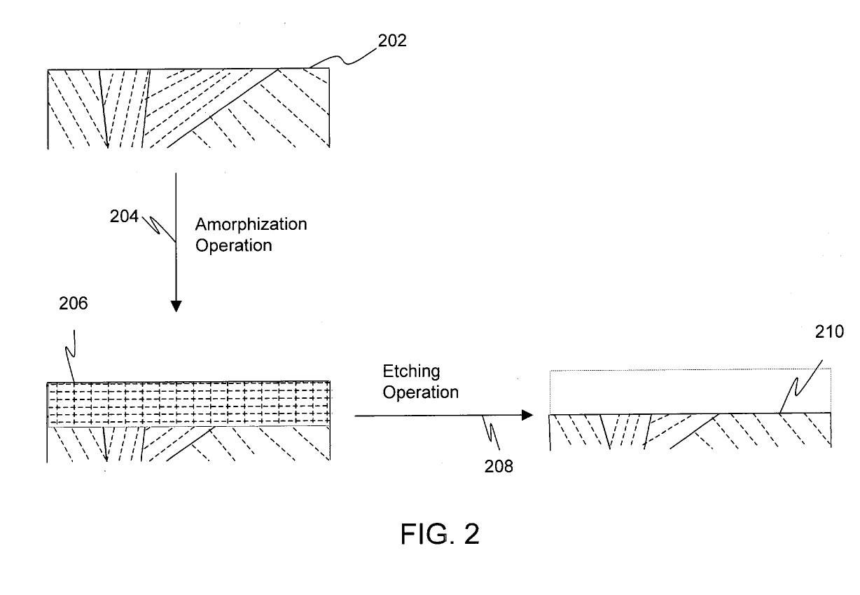

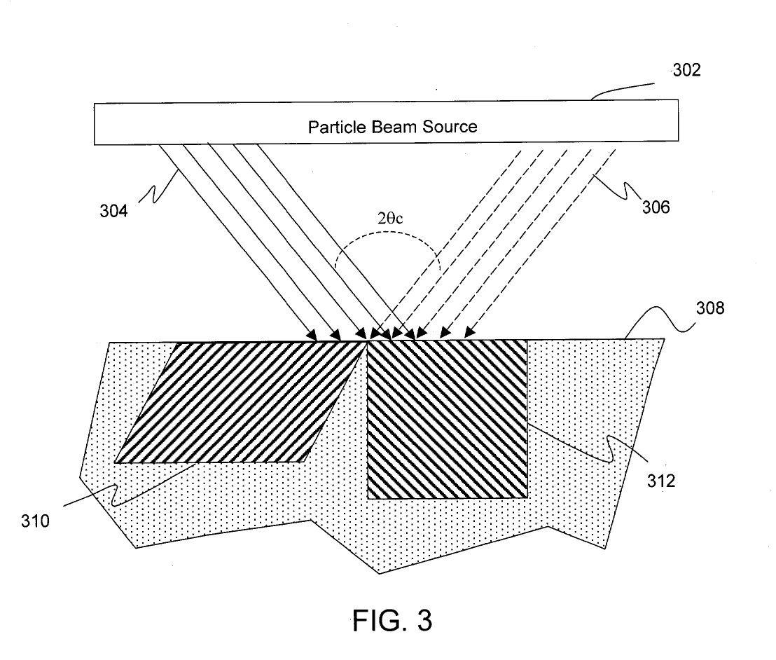

FIG. 2 is a schematic representation of the etching process in accordance with a preferred embodiment of the current invention. A substrate surface 202 to be etched is amorphized by an amorphization process 204 explained in greater detail in conjunction with FIG. 3. The amorphization process forms an amorphized layer 206 on the otherwise polycrystalline material. Amorphized layer 206 can thereafter be subjected to an etching operation 208. Etching operation 208 on amorphized layer 210 produces a uniformly etched surface 210.

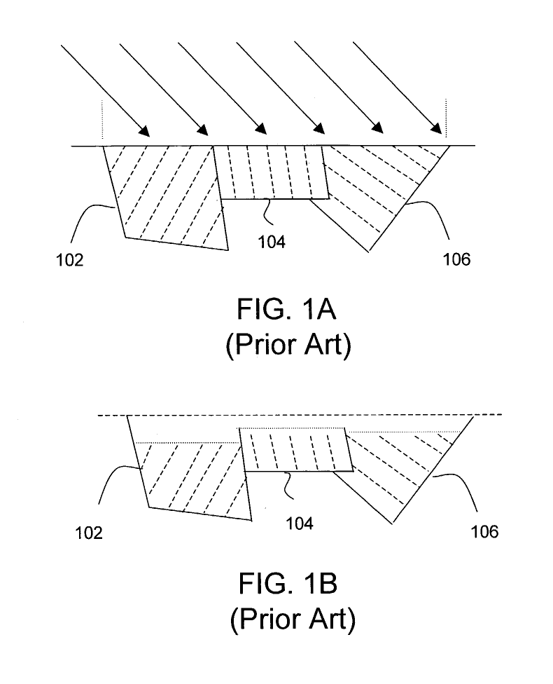

Surface 202 may constitute any crystalline material viz. monocrystalline or polycrystalline such as copper, silver, gold, titanium, polysilicon, etc. In case of a monocrystalline material, the atoms are arranged spatially in a regular repeating fashion. Such a material exhibits long-range order, i.e., the orientation of the atomic lattices is same across the entire crystal surface. In contrast, in a polycrystalline material, long-range order exists only within limited volume grains. Each such grain has a definite crystallographic orientation, different from its adjacent grains. A large number of such randomly arranged grains constitute the material. FIG. 1A depicts a typical surface in the case of polycrystalline material.

Amorphization operation 204 includes bombarding the surface of the substrate with one or more particle beams, to randomize long-range order. Amorphization operation 204 disrupts the existing crystallographic arrangement on the surface of the material, rendering it amorphous. An amorphous material exhibits no long-range order and periodicity. The bombarding beam comprises particles capable of strongly interacting with atomic lattices and breaking the bonds to render the surface amorphous. These particles may be, by way of example and not limitation, atoms, ions, neutrons, electrons, molecules etc. Exemplary particle beams include partially ionized gases such as an ionized argon beam and the like. It will be apparent to one skilled in the art that such a beam need not be a single particle beam. One or more particle beams can also be used without deviating from the scope of the current invention.

FIG. 3 depicts the amorphization process in accordance with a preferred embodiment of the current invention. A particle beam source 302 generates particle beams 304 and 306, which are incident on surface 308. Particle beams 304 and 306 are inclined at an angle that is twice the critical angle of channeling (i.e., 2θ0_{c}). The critical angle of channeling has been depicted as “θ_{c}” in FIG. 3. Particle beam source 302 may be a commercially available ion beam generator capable of providing a particle beam of desired energy, mass and chemistry. It may also possess means for controlling the exposure time for amorphization and the flux of incident beam. A preferred embodiment of the invention uses a focused ion-beam (FIB) source. Description of a suitable FIB source may be found in U.S. Pat. No. 5,140,164, titled “IC modification with focused ion beam system” assigned to Schlumberger Technologies Inc. (San Jose, Calif.), incorporated herein by reference. However, the invention is not limited by any particular particle beam source. For applying the ion beam sequentially at two different angles, the sample may be placed on a movable tilt stage that allows its rotation. Alternatively, the beam may be moved with respect to the sample by changing the beam direction.

The amorphization process of the present invention is performed by bombarding the material surface with two particle beams inclined at an angle to each other. The angle is at least twice the critical angle of channeling. In a preferred embodiment, only a single beam is used serially at two different angles to amorphize the operation region, these two angles must be separated by at least twice the critical angle of channeling.

The critical angle of channeling “θ_{c}” can be defined as the angle at which an ion (or particle) can enter a channel in a crystal structure without leaving it. As long as the component of the ion's energy perpendicular to the channel direction is smaller than the repelling potential of the atomic chain, the ion remains within the channel. For that to be fulfilled, the ion should move in a direction which is deviated from the direction of the channel by an angle less than the value of critical angle of channeling. This angle depends only on the ion energy, its atomic number, the atomic number of the target atoms and a specific dimension parameter for the given channel which is a property of the given crystal structure. If critical angle of channeling for a material is known with respect to a particle beam, then critical angle of channeling for the same material, with respect to another particle beam can be calculated. The other particle beam can be of different energy.

The formulation for calculation of the critical angle of channeling can be obtained from M. T. Robinson in “Sputtering by Particle Bombardment I”, ed. R. Behrisch, Springer-Verlag, Berlin-Heidelberg-New York 1981, p.99.

When particles are incident to a channel at an angle less than the critical value, the majority of the particles do not experience sufficiently strong interactions with the target atoms and therefore the crystal is said to be “transparent” in such directions. Due to the lack of strong interactions or collisions, the particles produce very little amorphization of the crystal. This is called “channeling effect”. There are two kinds of channeling, axial channeling and plane channeling. In plane channeling, the incident particles move in transparent direction limited by two crystallographic planes, whereas in axial channeling, the particles move in transparent direction limited by three or more crystallographic planes. Further details related to channeling and channeling effect can be obtained from J R Phillips, D P Griffis, and P E Russell, “Channeling effects during focused-ion-beam micromaching of copper”, J. Vac. Sci. Technol. A18 (2000) 1061.

The channeling effect is overcome in this invention as shown in FIG. 3. There are two particle beams 304 and 306 that bombard material surface 308. Material surface 306 has two grains 310 and 312. The cross hatching shown in FIG. 3 for grains 310 and 312 depict the difference in orientation of the two grains. Particle beam 304 amorphizes the grains on the surface which are favorably inclined to it, i.e., inclined at an angle greater than or equal to the critical angle of channeling, such as grain 310. Grains that are not favorably inclined to particle beam 304, such as grain 312, are not amorphized by it due to the channeling effect. This is because grain 312 is inclined at an angle less than the critical angle of channeling to beam 304. These grains are amorphized by particle beam 306, which is inclined at twice the critical angle of channeling, to particle beam 304. Similarly beam 306 will have little effect on grain 310 but will amorphize grain 312 which is inclined at twice the critical angle of channeling, to particle beam 306. By using two beams inclined with respect to each other at twice the critical angle of channeling, uniform amorphization of the substrate surface is ensured even in case of a polycrystalline surface with different grain orientations on the surface. In case of surfaces of polycrystalline materials, the two particle beams are inclined at an angle greater than twice the critical angle of channeling for the most open direction in the lattice of the material. Instead of using two different beams, a single beam operating at two different angles can also be used. The difference between the two angles should be at least twice the critical angle for channeling. In an alternative embodiment, a single particle beam can be incident on the polycrystal material surface at an angle more than the critical angle of channeling to the surface normal. The polycrystal material can then be rotated so as to maintain same beam inclination with respect to the surface normal, i.e. greater than θ_{c}. Therefore, if we continuously rotate the polycrystal material, complete amorphization of the material surface can be achieved.

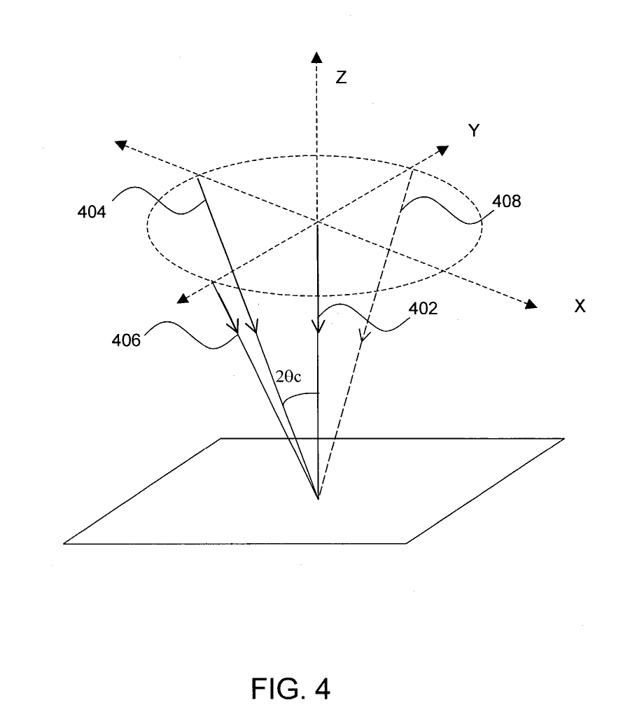

However, for polycrystalline materials where plane channeling is dominant, an additional particle beam bombardment is used. When the plane formed by first and second bombardment directions is inclined to the plane of plane channel at an angle smaller than the critical angle of channeling, the first two bombardments do not completely amorphize the crystal structure requiring an additional beam bombardment. The additional beam must be at an azimuth angle different from the other two beams by 90 degrees. FIG. 4 illustrates the relative directions of the incident particle beams to overcome plane channeling effect in materials. A particle beam 402 is directed along one axis in the Cartesian coordinate system (i.e. Z direction as shown in the FIG. 4). A second beam 404 is inclined at an angle twice that of the critical angle of channeling (2θ_{c}) to beam 402. Beam 404 has an azimuth angle equal to zero. A third beam is bombarded on the material surface. This third beam should have the same inclination to beam 402 as beam 404 but with an azimuth angle equal to +/−90 degrees i.e. the third beam should lie in the plane perpendicular to the plane formed by beams 402 and 404. Therefore, the third beam can be in any one of the directions 406 and 408, as shown in FIG. 4. This will provide amorphization in case of plane channeling.

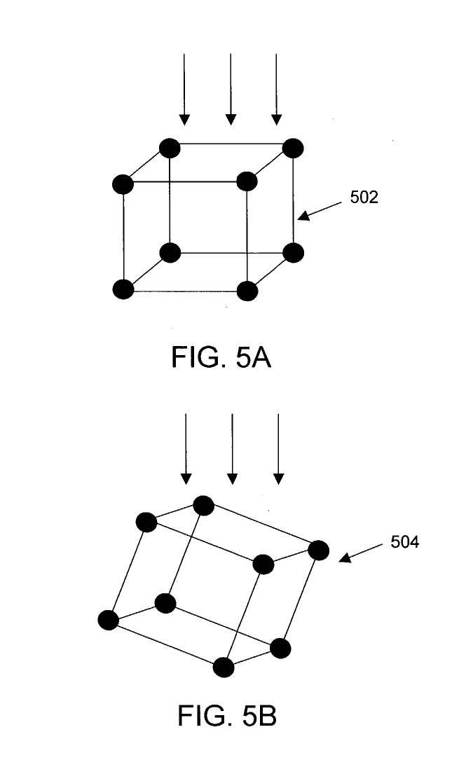

FIG. 5 illustrates two possible orientations of a crystal lattice structure in polycrystalline materials. FIG. 5A shows particle bombardment on a simple cubic lattice structure 502 in one of the orientations, while FIG. 5B shows particle bombardment on another simple cubic lattice structure 504 having a different orientation. During the process of amorphization, an ion beam is passed through the two lattice structures as shown in FIG. 5A and FIG. 5B. As can be seen from the figures, simple cubic structure 504 will provide greater obstruction to an ion beam passing through it as compared to simple cubic structure 502 because of the difference in orientations. A crystal lattice is said to be more open in a particular direction if the number of atoms packed per unit area in that direction is less as compared to the other direction. For example, simple cubic lattice 502 would be more open than simple cubic lattice 504 for the given particle bombardment. In case there exists a polycrystalline material with these two crystal orientations, for amorphization the inclination of the particle beam should be at least twice the critical angle of channeling for the most open lattice structure, e.g. the simple cubic structure 502.

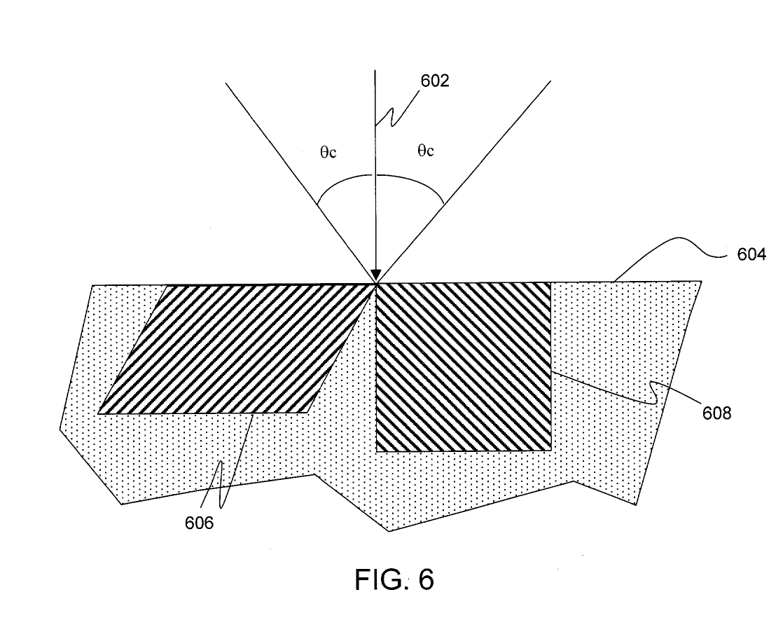

FIG. 6 illustrates the two-angle amorphization arrangement used in the present invention. It shows the situation when a beam 602 is incident perpendicular to the surface of substrate 604. This operation amorphizes all the grains whose open orientation is inclined to the surface normal by an angle equal or greater than the critical angle of channeling. Grains 606 and 608 have their open orientation inclined to the surface normal by an angle less than the critical angle for channeling “θ_{c}” but, opposite in directions to each other. In order that both grains were amorphized under the second bombardment, it is necessary that the second beam should strike at an angle at least twice the value of critical angle for channeling to the first beam. This ensures that all the grains on the surface of the material are amorphized.

Although the amorphization process has been described as using two particle beams, it is apparent to one skilled in the art that multiple beams can also be used. Also, for monocrystalline surfaces, a single beam may be sufficient to amorphize the surface.

For amorphization in deeply buried narrow trace, the beams have to be tilted at different angles. The particle beams should be tilted along the axis of the narrow trace so as not to affect higher-level metallizations. This is required for cutting a deeply buried narrow trace with minimum damage to the underlying and adjacent dielectric.

Once the surface is amorphized, it can be etched using any etching technique such as wet chemical etching, plasma etching, reactive ion beam etching and broad ion beam etching. Although certain etching techniques have been mentioned, it is apparent to one skilled in the art that any other etching methods can also be used. The kind of etching process used will however be dependent upon the feature requirements and the material to be etched. If the surface is required to be etched isotropically, that is, etching proceeds in all directions at the same rate, wet etching can be used. Here the etchants chemically react with surface atoms and dissolve them. For example, a mixture of nitric and hydrofluoric acids can be used to etch away silicon. Similarly, aqueous hydrofluoric acid can etch away silicon dioxide substrates. For wet chemical etching, usually the substrate is immersed in the etchant bath for a specified period of time to achieve the desired depth of etching. However, for etching minute features on the substrate surface, anisotropic etching is required, i.e., etching should preferentially proceed in a particular direction. In such cases, preliminary surface preparation may be followed by dry or plasma etching techniques. Here the surface is etched away by physical bombardment with a plasma or ion beam, and the atoms are dislodged from the surface, by collision caused by high-energy incident particles of the beam. For very minute features, a focused ion beam will prove to be more useful. Dry etch processes usually occur in a reactor where the substrate is placed in a vacuum chamber, gases are admitted to the chamber, and a plasma is initiated in the gas. This plasma is then energized under a voltage difference and made incident at high energy on the substrate surface. Reactive species generated in the plasma react with the sample surface and create volatile etch products that are then swept away. For etching of thick films, the amorphization and etching operation may be alternated repeatedly.

Alternatively, in ion beam or plasma beam etching, one of the two particle beam bombardments, is carried out along with the etching process. Thus, only one particle beam bombardment, at an angle of at least twice the critical angle of channeling to the direction of the etching process, is required. The second bombardment is carried out along with the etching process.

### EXAMPLE

In order to test and verify the effectiveness of the preliminary surface preparation using the two-angle amorphization scheme, a laboratory test was conducted. The test compared the results of Focused Ion Beam (FIB) etching of copper films with and without the use of the surface amorphization step prior to etching. Copper, being polycrystalline in nature, shows very uneven etching under normal conditions. An IDS P3X FIB instrument (available from NPTest, Inc) was used to generate a Focused Ion Beam of 30 keV Ga⁺ ions. The sample being tested consisted of a copper film deposited on a silicon dioxide dielectric on a silicon substrate. The copper film contained vertical silicon dioxide pillars coming out through the film and having height equal to the copper film thickness. These pillars were initially embedded into the copper film. The residuals of pillars were used to gauge the etching selectivity of copper over the dielectric. Ideally, etching of the copper film to a certain depth should be accompanied by minimum etching of the dielectric pillars.

In one example, the etching operation was performed without preliminary surface preparation. The experimental sample was placed in a partial pressure of ammonia and water vapor, which acted as a copper etch assisting agent. Further details on the use of ammonia and water vapor as copper etch assisting agent, may be obtained from patent application Ser. No. 10/227,754, titled “Process for charged particle beam micro-machining of copper”, and filed on Aug. 26, 2002, incorporated herein by reference. Owing to its polycrystalline grain structure, copper is etched with an ion beam very unevenly. Hence such copper-etch assistance agents need to be used to protect the underlying and adjacent dielectric material from damage in those areas where etching process proceeds faster. The ion beam current used was 1 nA. Under these experimental conditions, the sample took 58 minutes for a clean elimination of the copper film. The dielectric pillars were significantly eroded, some of them milled down to the base.

The other sample was mounted on a tilt stage for allowing the tilting of the sample to angles between 0 and 60 degrees with respect to the ion beam. Etching using ion beam bombardment is performed at an angle (20 degrees) with respect to the first particle beam bombardment. In this case, the ion beam used for etching of the surface also acts as the second beam for amorphization.

The critical channeling angle for 30 keV Ga⁺ ions in the most open direction of copper was taken as 10 degrees. The surface was amorphized with the beam using a beam current of 1 nA. The exposure time was 5 minutes, during which, the sample was exposed to one ion beam tilted at an angle of 20 degrees to the surface normal. The etching operation was then carried out in an atmosphere of ammonia and water vapors, as before. Under these experimental conditions, the sample took 33 minutes for complete copper elimination. The dielectric pillars were protected in a significantly better way and they were not milled down to the base.

A comparison of results of the two experiments shows that using the two-angle amorphization scheme disclosed by the invention a more uniform etching was achieved. The time for complete etching was significantly reduced, which also means that the dielectric pillars were subjected to the etching operation for a lesser period of time. The lower degree of damage to the dielectric pillars indicates this. Thus, for polycrystalline materials such as copper, surface preparation through amorphization results in better protection of underlying substrate and neighboring dielectric from damage.

In the sample that was subjected to the amorphization step of the present invention, the grain structure is disrupted on the entire surface and the entire operation region is uniformly oriented to etching. However, in case of the other sample, which was etched without surface preparation, there are some grains that are unfavorably oriented to etching. These unfavorably oriented grains take more time to etch away as compared to the favorably oriented grains thereby increasing the overall time required for complete etching.

Applications and Advantages

An application of the current invention is for polycrystalline films that need to be etched away uniformly. For example, copper, a polycrystalline material, is widely used as conductor material when making connections on semiconductor substrates, printed circuit cards, magnetic thin film heads etc. The conventionally used steps of photolithography for making these connections can be supplemented with the described method for achieving superior etching rates and etch quality. The amorphization of the material surface homogenizes the etching rates across the surface, thus ensuring uniform etching.

This invention is also applicable to films that are not on a material surface but have been embedded in layers of materials, such as those found in the present generation of integrated circuits. These integrated circuits may comprise alternating layers of silicon dioxide (SiO₂) and patterned copper on a substrate of doped silicon. Other dielectric materials, for which the invention may be applicable, include, by way of example and not limitation, materials with low dielectric constants (k), such as organic silicon oxides, fluorinated silicon oxides and combinations thereof. Alternatively, these low-k dielectrics can be combined with silicon carbide, silicon nitride and silicon oxide. Still further examples of dielectric materials include fluorinated silicate glass (FSG), carbon-doped siloxanes or organosilicate glass (OSG), hydrogen silsesquioxane (HSQ), other silicon glasses, and combinations thereof. Materials with high-k for which the invention is applicable include hafnium oxide, silicon carbide, zirconium oxide, silicon monoxide, tantalum oxide, etc.

The metal interconnect is exposed by cutting a hole in the region above the metal interconnect surface, using standard material-layer removal techniques used in IC editing. Further information regarding etching techniques for IC editing can be obtained from H Ximen, C. G. Talbot, “Halogen-based selective FIB Milling for IC Probe-Point creation and repair”, 20^{th} ISTFA Proceedings 1994, 141. Subsequently, the method of etching as disclosed in the present invention can be carried out on the exposed metal surface.

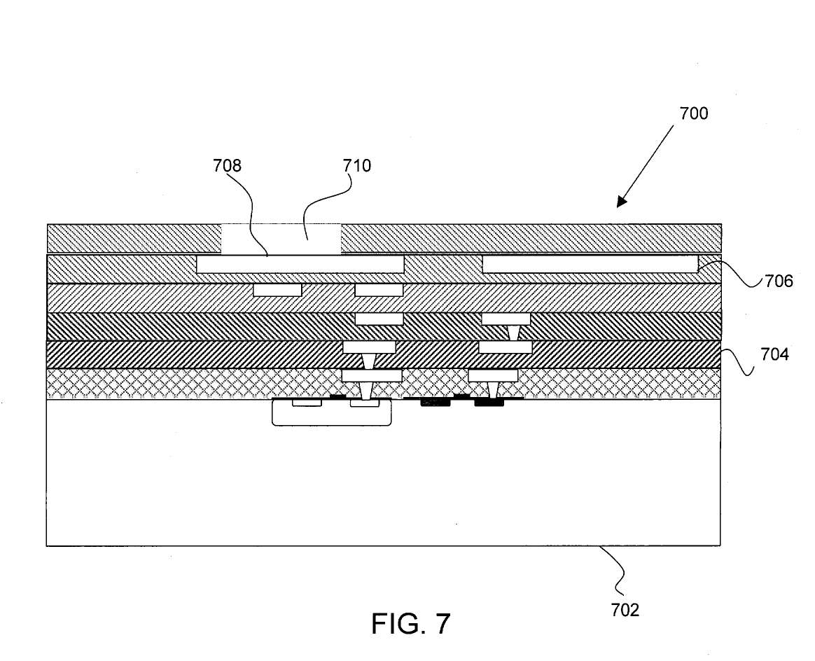

FIG. 7 shows the application of the present invention in case of embedded metallic surfaces in integrated circuits. A cross-sectional view of an integrated circuit 700 is shown. Integrated circuit 700 comprises of a silicon substrate 702, silicon oxide layers 704 and metallic interconnects 706. An embedded metallic surface 708 is to be amorphized prior to etching. The insulator layer over metallic surface 708 is removed leaving a cavity 710. Thus the metal surface can be accessed and the process of etching as disclosed in the present invention can be carried out in case of embedded metallic interconnects.

For etch polishing a substrate surface prior to a thin film deposition, the use of the present invention results in clean and uniform surfaces, leading to good quality film deposition.

The present invention also provides better control over the etching process because of uniform etching across the surface achieved due to amorphization. Thus, the etching process can be more effectively controlled.

The use of the present invention leads to amorphization of all the grains as the channeling effect is overcome. Therefore, the etching process using the present invention takes less time than etching using prior art methods.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A method for amorphization of materials having a grain orientation using particle beam bombardment, the method comprising the steps of:
a. bombarding a first particle beam at the material surface, the first particle beam being inclined at an angle to the grains of the bombarded material, the angle being greater than the critical angle of channeling; and
b. bombarding a second particle beam, the second particle beam being inclined at an angle to the first particle beam, the second beam amorphizing the remaining grains on the material surface.

2. The method of claim 1 wherein the angle between the first particle beam and the second particle beam is at least twice that of the critical angle of channeling.

3. The method of claim 1 further comprising the step of bombarding a third particle beam at an azimuth angle different from the azimuth angle of the first beam and the second beam by 90 degrees, to thereby overcome the plane channeling effect.

4. The method of claim 1 wherein the first particle beam is incident along the surface normal and the second particle beam is incident at an angle to the first beam, the angle being twice that of the critical angle of channeling to the surface normal.

5. The method of claim 1 wherein the first particle beam and the second particle beam is a single beam serially incident at two different angles.

6. The method of claim 1 wherein the material surface is rotated thereby allowing the use of a single particle beam inclined at an angle to the surface normal for amorphization.

7. The method of claim 1 wherein the particle beam is an ion beam.

8. The method of claim 1 wherein the material is at least one of: a monocrystalline material and a polycrystalline material.

9. A method for material removal from a solid surface, the material having a grain orientation, the method comprising the steps of:
a. bombarding a first particle beam at the material surface, the first particle beam amorphizing grains of the material inclined at an angle to the first particle beam, the angle being greater than the critical angle of channeling;
b. bombarding a second particle beam, the second particle beam being inclined at an angle to the first particle beam, the second particle beam amorphizing the remaining grains of the material on the surface; and
c. etching the amorphized layer of the solid surface.

10. The method of claim 9 wherein the angle between the first particle beam and the second particle beam is at least twice that of the critical angle of channeling.

11. The method of claim 9 wherein the particle beam is an ion beam.

12. The method of claim 9 wherein the material is at least one of: a monocrystalline material and a polycrystalline material.

13. The method of claim 9 wherein the solid is a metal interconnect embedded in an integrated circuit.

14. The method of claim 9 wherein the method is used to expose embedded metallization regions for editing.

15. The method of claim 9 wherein the etching process is selected from a group consisting of ion beam etching, plasma beam etching and wet etching.

16. The method of claim 9 wherein the etching process is focused particle beam etching.

17. The method of claim 9 wherein the step of etching acts as the second particle beam for amorphization.

18. The method of claim 9 wherein the method is used to cut narrow traces.

19. A method for surface preparation to enable uniform etching of a material having a grain orientation, the method comprising the steps of:
a. bombarding a first particle beam at the material surface, the first particle beam amorphizing grains inclined at an angle to the first particle beam, the angle being greater than the critical angle of channeling; and
b. bombarding a second particle beam, the second beam being inclined at an angle to the first particle beam, the second beam amorphizing the remaining grains of the material on the material surface.

20. The method of claim 19 wherein the angle between the first particle beam and the second particle beam is at least twice that of the critical angle of channeling for the material.

21. The method of claim 19 wherein the particle beam is an ion beam.

22. The method of claim 19 wherein the material is at least one of: a monocrystalline material and a polycrystalline material.

23. The method of claim 19 wherein the material is a metal interconnect embedded in an integrated circuit.
